(19) United States
(12) Patent Application Publication
(10) Pub. No.: US 2003/0192467 A1
(43) Pub. Date: Oct. 16, 2003

(54) Automatic flag untangler

(76) Inventor: Robert Burton Paris, Goodyear, AZ (US)

Correspondence Address: ROBERT B. PARIS, 15007 W. FAIRMOUNT AVE., GOODYEAR, AZ, 85338, US

(21) Appl. No.: 10/123,104

(22) Filed: Apr. 15, 2002

(51) Int. Cl. G09F 17/00

(52) U.S. Cl. 116/173

(57) ABSTRACT

This is a very simple arrangement, easily used and installed by almost anyone. It differs from the nearest patented counterpart in minimizing parts, construction, and expense of production. And it works.

The parts are interchangeable, and may be used on any sized flag or pennant. With this design, more than one flag/pennant may be used on the same pole without any additional changes to the design, and all installed flag/pennants will be kept untangled without one being dependant on the other.

Several design modifications are submitted for using various fixed and rotating cuffs, and materials for attaching flags to same, all of which are of very simple construction and manufacturing.

This is a simple, inexpensive system which automatically permits flags to float freely and to disentangle themselves when tangled around a flagpole due to varying wind conditions.

It is designed to be used mainly on horizontal or upward-angled poles, though it may be used on vertical poles in some cases.

The system consists of small rotating cylinders to which the flag or pennant is attached, the cylinders being held in correct position by fixed cylinders which position the flag on the pole, and permit the rotating cylinders to hold the flag in the correct position.

### DETAILED DESCRIPTION

There are a number of flag unfurlers/untanglers that have been patented, but are mostly difficult and expensive to construct and install. The present application is very simple, and inexpensive to manufacture, and may be installed with just a screwdriver.

Additionally, present application may be used for many different sizes of flags without additional modification, and may also be used for installation of multiple flags/pennants without modification; all parts being interchangeable regardless of size of flag or position.

### CLAIMS

This application has been thoroughly tested by being in actual use over a 7 month period, using a 3×5 foot flag on a standard metal pole mounted on a home. Over this period of time, 24 hours per day, in all type of weather and variable winds, the flag has had to be manually untangled only once, due to a fierce windstorm which caused the flag to be caught on the wingtip of a metal eagle used as the pole cap. Numerous other flags flown on homes in the same neighborhood, using ordinary tie-downs, have had to be manually restored to normal flying conditions on many occasions; several having actually been torn from their moorings due to excessive winds. Some home-owners flying flags have discontinued their use after being discouraged by having to continually untangle their flags manually.

### ABSTRACT OF DISCLOSURE

This is a very simple arrangement, easily used and installed by almost anyone. It differs from the nearest patented counterpart in minimizing parts, construction, and expense of production. And it works.

### BRIEF DESCRIPTION OF DRAWINGS

Drawing Sheet 1, FIG. 1.

This is a drawing of the complete invention, installed on flagpole, using one system of attachments to pole. Other systems of attachments may be equally effective, using variations of attaching fixed and rotating cylinders. Some of these are demonstrated on following Drawing Sheets.

FIG. 1, 1. Flagpole 2. rotating cylinder to which flag is attached, top and bottom at flag grommets 3,. Screweye 4. fastening such as wire, cord, laces, etc.

5. flag with grommets 6. fixed cuff or cylinder used to hold cylinder #2 in position. Note same cuffs are used at bottom of flag with positions reversed to fit flag grommets in position.

7. Screw to hold fixed cylinder in position to keep it from sliding on pole.

FIG. 2., Alternate fastening system, providing groove around rotating cylinder to which wire or cord is attached, instead of screweye.

FIG. 3. Same as FIG. 2, except cylinder reversed to fit to lower grommet on flag.

Drawing Sheet 2, FIG. 4. Alternate design, #8 for rotating cylinder. Cylinder to be of molded material, in size relation to fixed cylinder 6.

FIGS. 5, 6 Side and top views of rotating cylinder #8, Drawing Sheet #3, FIG. 7. Another alternate design for rotating cylinder, #9. This is a molded piece with center hole, and angled slot in which to insert flag grommet without additional tie-ons. Flag grommet is forced into slot, which being angled, will not permit grommet to retract unless manually induced to do so.

FIGS. 8, 9, 10 Top, side, front view of cuff #9.

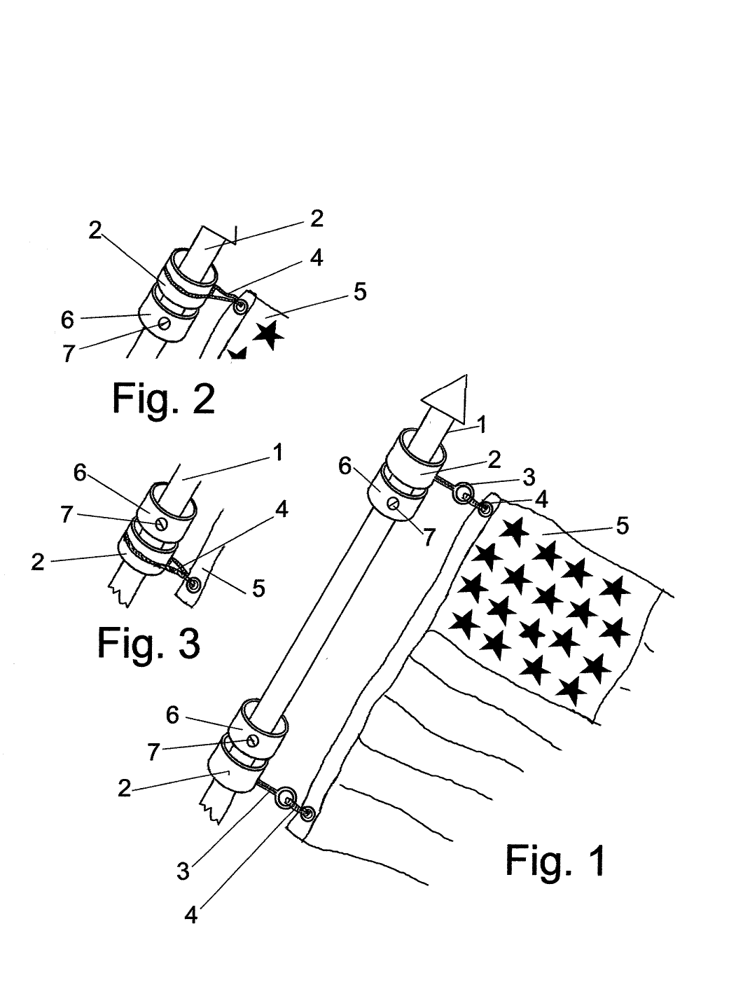

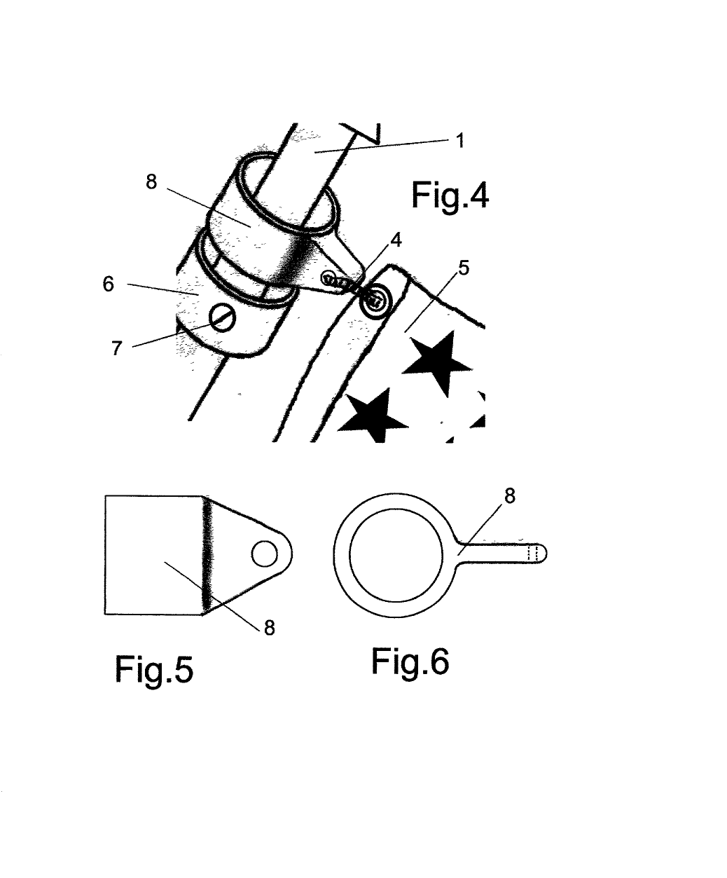

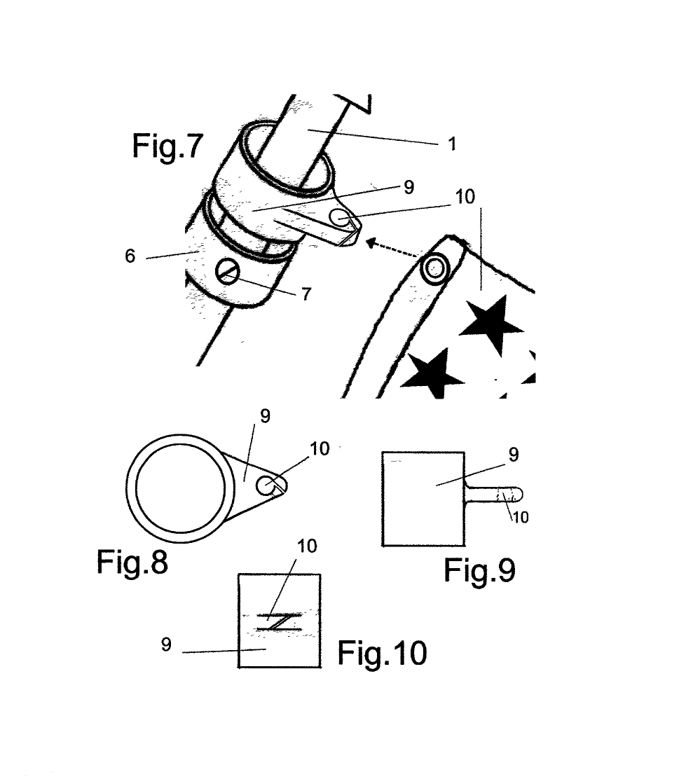

While these drawing represent 3 different methods of using rotator cylinders, it is likely that other cylinder/attachments designs may be produced. This patent is designed to cover these different designs, as all would be used to produce the same untangling results.

1. This is a simple, inexpensive system which automatically permits flags to float freely and to disentangle themselves when tangled around a flagpole due to varying wind conditions.
It is designed to be used mainly on horizontal or upward-angled poles, though it may be used on vertical poles in some cases.
The system consists of small rotating cylinders to which the flag or pennant is attached, the cylinders being held in correct position by fixed cylinders which position the flag on the pole, and permit the rotating cylinders to hold the flag in the correct position.
There are a number of flag unfurlers/untanglers that have been patented, but are mostly difficult and expensive to construct and install. The present application is very simple, and inexpensive to manufacture, and may be installed with just a screwdriver.
Additionally, present application may be used for many different sizes of flags without additional modification, and may also be used for installation of multiple flags/pennants without modification; all parts being interchangeable regardless of size of flag or position.
This application has been thoroughly tested by being in actual use over a 10 month period, using a 3×5 foot flag on a standard metal pole mounted on a home. Over this period of time, 24 hours per day, in all type of weather and variable winds, the flag has had to be manually untangled only once, due to a fierce windstorm which caused the flag to be caught on the wingtip of a metal eagle used as the pole cap. Numerous other flags flown on homes in the same neighborhood, using ordinary tie-downs, have had to be manually restored to normal flying conditions on many occasions; several having actually been torn from their moorings due to excessive winds. Some home-owners flying flags have discontinued their use after being discouraged by having to continually untangle their flags manually.
This is a very simple arrangement, easily used and installed by almost anyone. It differs from the nearest patented counterpart in minimizing parts, construction, and expense of production. And it works.
